(19) United States
(12) Patent Application Publication
(10) Pub. No.: US 2014/0227586 A1
(43) Pub. Date: Aug. 14, 2014

(54) BATTERY PACK

(71) Applicant: Samsung SDI Co., Ltd., Yongin-si (KR)

(72) Inventor: Bohyun Byun, Yongin-si (KR)

(21) Appl. No.: 13/924,422

(22) Filed: Jun. 21, 2013

(30) Foreign Application Priority Data
Feb. 8, 2013 (KR) 10-2013-0014476

(51) Int. Cl. H01M 2/02

(52) U.S. Cl. CPC H01M 2/0202
USPC 429/179

(57) ABSTRACT

A battery pack, which can be easily combined with a set and can increase capacity, is disclosed. The battery pack includes a bare cell having electrode terminals protruding on a first surface, and a lower cover coupled to a second surface of the bare cell. The lower cover includes a flange fastening part protruding away from the bare cell. The flange fastening part has a fastening hole formed therein.

### CROSS-REFERENCE TO RELATED APPLICATION

This application claims the benefit of Korean Patent Application No. 10-2013-0014476 filed on Feb. 8, 2013, the contents of which are incorporated herein by reference in their entirety.

### BACKGROUND

1. Field

Aspects of the present disclosure relate to a battery pack, which can be easily combined with other battery packs in a product set, and which may have increased electrical capacity.

2. Description of the Related Technology

A lithium battery may be manufactured in form of a battery pack. The battery pack may include a bare cell with an electrode assembly having a positive electrode plate, a negative electrode plate, and a separator. The battery pack may also include a case accommodating the electrode assembly, a cap assembly sealing a top end opening of the case, a circuit module including a circuit device, such as a charge/discharge device or a protection circuit device, and an external cover covering the circuit module.

### SUMMARY OF CERTAIN INVENTIVE ASPECTS

In one aspect, a battery pack is provided, which can be easily combined with other battery packs in a product set and may have increased electrical capacity.

In another aspect, a battery pack is provided that includes, for example, a bare cell having electrode terminals protruding toward its upper portion, and a lower cover coupled to a lower portion of the bare cell.

In some embodiments, the lower cover includes a flange fastening part protruding toward the outside of the bare cell and has a fastening hole formed therein to be fastened with the set. In some embodiments, the lower cover may be adhered to a bottom surface of the bare cell by an adhesion member. In some embodiments, the lower cover may include a cell support part protruding to surround the plate making contact with the bottom surface of the bare cell and the lower portion of the bare cell to be combined with the bare cell. In some embodiments, the battery pack may further include an adhesion member formed between the plate of the lower cover and the bottom surface of the bare cell. In some embodiments, the flange fastening part of the lower cover may be formed at opposite edges of the lower cover in view of a lengthwise direction of the lower cover. In some embodiments, the flange fastening part of the lower cover may protrude toward the lower portion of the bare cell. In some embodiments, the flange fastening part of the lower cover may protrude from the cover to a side portion of the lower portion of the bare cell and may extend in a lengthwise direction of the bare cell. In some embodiments, the flange fastening part of the lower cover may have a cell fastening surface shaped corresponding to the bare cell in a region contacting opposite ends of the lower portion of the bare cell. In some embodiments, the flange fastening part of the lower cover may have the flange fastening surface flatly formed to make contact with the set. In some embodiments, the fastening hole of the lower cover may have a screw thread formed therein. In some embodiments, the lower cover may further include a reinforcement part formed between the plate making contact with the bottoms surface of the bare cell and the flange fastening part. In some embodiments, the reinforcement part may have a thickness of about 0.4 mm or greater. In some embodiments, the reinforcement part may include a groove shaped of an arc corresponding to the shape of the fastening hole. In some embodiments, the lower cover may include a cell support part protruding from the plate making contact with the bottom surface of the bare cell to surround the lower portion of the bare cell in the lengthwise direction. In some embodiments, the reinforcement part may have a thickness smaller than that of the cell support part.

As described above, in the battery pack according to some aspects of the present disclosure, the flange fastening part may be formed to protrude in the lower cover such that it is positioned and configured to fasten the set, and a throughhole is formed in flange fastening part to allow a fastening member to pass therethrough, thereby easily combining the battery pack with the set using the fastening member in a state in which the battery pack is aligned with the set and increasing manufacturability while reducing the manufacturing cost by simplifying components.

In addition, in the battery pack according to some aspects of the present disclosure, since it is not necessary to provide a separate fixing unit, the size of the bare cell can be increased, thereby increasing electrical capacity of the battery pack.

In another aspect, a battery pack may be combined with and configured to supply power to a product set. Manufacturing cost of the battery pack can be reduced as compared to structures known in the art by simplifying a coupling structure of the battery pack in the product set, thereby increasing speed of assembly and manufacturability of the product set.

Additional aspects and/or advantages of the invention will be set forth in part in the description which follows.

### BRIEF DESCRIPTION OF THE DRAWINGS

The aspects, features and advantages of the present disclosure will be more apparent from the following detailed description in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a perspective view of a battery pack according to an embodiment of the present disclosure.

FIG. 2 is an exploded perspective view of the battery pack shown in FIG. 1.

FIG. 3 is an enlarged perspective view illustrating a lower cover in the battery pack shown in FIG. 1.

FIG. 4 illustrates the lower cover shown in FIG. 3 is vertically reversed.

FIG. 5 illustrates a state in which the lower cover is coupled to a lower portion of a bare cell in the battery pack shown in FIG. 1.

FIG. 6 is a perspective view illustrating a lower cover of a battery pack according to another embodiment of the present invention.

FIG. 7 is a bottom view of the lower cover of FIG. 6.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. The drawings and description are to be regarded as illustrative in nature and not restrictive. However, it should be understood that the disclosure is not limited to a specific embodiment but includes all changes and equivalent arrangements and substitutions included in the spirit and scope of the disclosure. Descriptions of unnecessary parts or elements may be omitted for clarity and conciseness, and like reference numerals refer to like elements throughout. In the drawings, the size and thickness of layers and regions may be exaggerated for clarity and convenience.

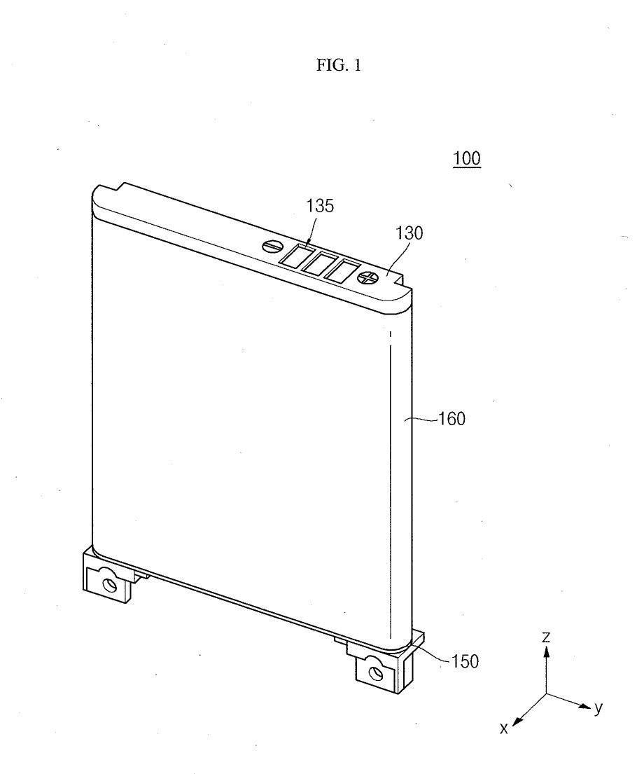

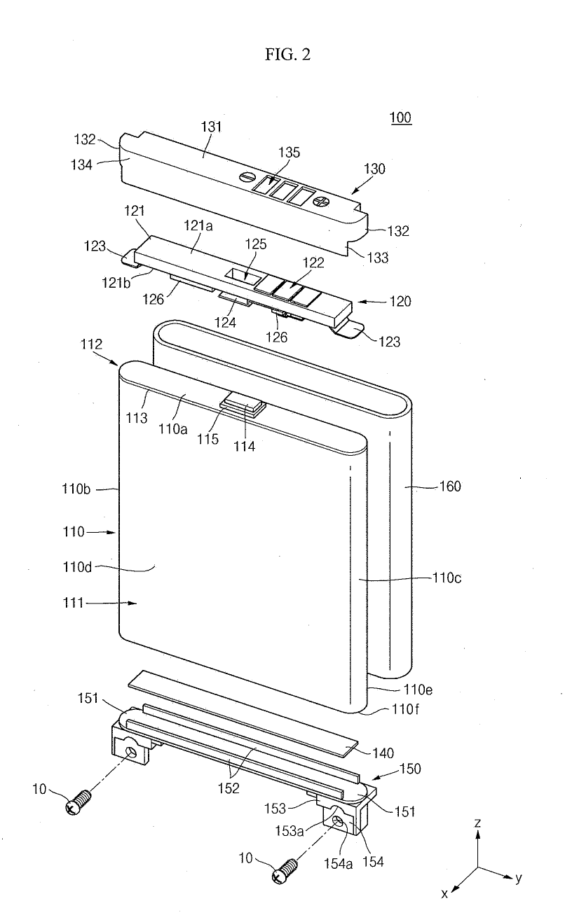

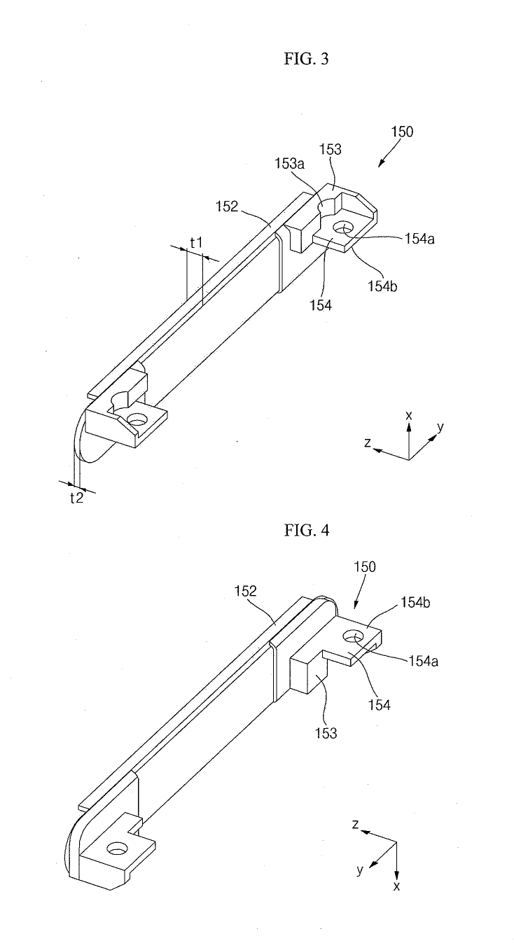

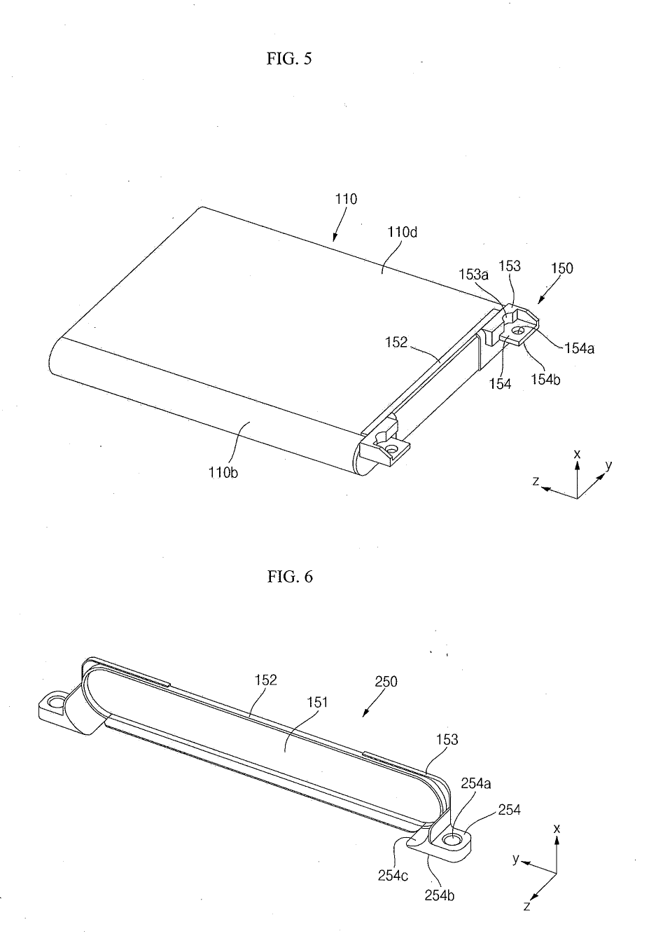

FIG. 1 is a perspective view of a battery pack according to an embodiment of the present disclosure, FIG. 2 is an exploded perspective view of the battery pack shown in FIG. 1, FIG. 3 is an enlarged perspective view illustrating a lower cover in the battery pack shown in FIG. 1, FIG. 4 illustrates the lower cover shown in FIG. 3 is vertically reversed, and FIG. 5 illustrates a state in which the lower cover is coupled to a lower portion of a bare cell in the battery pack shown in FIG. 1.

Referring to FIGS. 1 to 5, a battery pack 100 includes a bare cell 110, a circuit module 120, an upper cover 130, and a lower cover 150. Optionally, an adhesion member 140 may further be formed between the bare cell 110 and the lower cover 150.

The bare cell 110 may include an electrode assembly (not shown) configured to supply electrical energy and includes a positive electrode, a negative electrode, and a separator interposed between the positive electrode and the negative electrode; a vessel-type case 111 formed of a metal and accommodating the electrode assembly and an electrolyte (not shown); and a cap assembly 112 sealing an opening of the case 111. Here, the cap assembly 112 may include a cap plate 113 formed of a metal, an electrode terminal 114 protruding on the cap plate 113, and a gasket 115 interposed between the cap plate 113 and the electrode terminal 114 and insulating the electrode terminal 114 from the cap plate 113.

The case 111 or the cap plate 113 may be configured to serve as positive or negative terminals. The embodiment of FIGS. 1 to 5 will be described below assuming that, the case 111 or the cap plate 113 may serve as a positive electrode. Accordingly, it is assumed that the electrode terminal 114 may be configured to serve as a negative electrode having a polarity opposite to that of the case 111. Of course, the case 111, polarities of the cap plate 113 and the electrode terminal 114 may be reversed.

The bare cell 110 may have a top surface 110a on which the electrode terminal 114 protrudes in a state in which it is insulated from the bare cell 110 by the gasket 115, a pair of short-side surfaces 110b and 110c and a pair of long-side surfaces 110d and 110e connected to the top surface 110a, and a bottom surface 110f connected to the side surfaces 110b, 110c, 110d, and 110e and facing the top surface 110a. Here, the pair of short-side surfaces 110b and 110c are relatively narrow-wall side surfaces among the side surfaces 110b, 110c, 110d, and 110e connected to the top surface 110a of the bare cell 110, and the pair of long-side surfaces 110d and 110e are wide-wall side surfaces among the side surfaces 110b, 110c, 110d, and 110e connected to the top surface 110a of the bare cell 110.

The circuit module 120 is disposed on the bare cell 110 and is electrically connected to the bare cell 110. The circuit module 120 may include a circuit board 121, an external terminal 122, a first lead plate 123, a second lead plate 124, a welding hole 125 and a circuit device 126. The circuit board 121 may have a plate shape and may be formed of a resin. The circuit board 121 may have a top surface 121a and a bottom surface 121b. Meanwhile, in the present disclosure, in this embodiment the top surface 121a of the circuit board 121 is the same as a top surface of the circuit module 120, and the bottom surface 121b of the circuit board 121 is the same as a bottom surface of the circuit module 120. The external terminal 122 is installed on the top surface 121a of the circuit board 121 and electrically connects the circuit board 121 to an external electronic device (not shown).

A pair of first lead plates 123 may be provided to then be connected to ends of the circuit module 120 and are electrically connected to a positive electrode wiring pattern of the circuit module 120. In addition, the pair of first lead plates 123 may extend toward the top surface 110a of the bare cell 110 to be connected to the top surface 110a of the bare cell 110 by resistance welding. Therefore, the first lead plates 123 electrically connect the bare cell 110 to the circuit module 120. The first lead plates 123 are formed of a metal, such as nickel or a nickel alloy. Here, the first lead plates 123 may function as a positive electrode, like the top surface 110a (for example, the cap plate 112) of the bare cell 110.

The second lead plate 124 is installed on a bottom surface 121b of the circuit board 121 and may be electrically connected to a negative electrode wiring pattern (not shown) of the circuit module 120. In addition, the second lead plate 124 may be electrically connected to the electrode terminal 114 by resistance welding through the welding hole 125. The second lead plate 124 may be formed of a metal, such as nickel or a nickel alloy. Here, the second lead plate 124 may function as a negative electrode, like the electrode terminal 114.

The welding hole 125 is formed to pass through the top surface 121a and the bottom surface 121b of the circuit board 121. The welding hole 125 is located at a region corresponding to the electrode terminal 114 of the bare cell 110 and provides a space in which the second lead plate 124 is welded to the electrode terminal 114 of the bare cell 110.

The circuit device 126 may be formed on the bottom surface 121b of the circuit board 121, and may include charge/discharge circuits and a protection circuit. The circuit device 126 may be electrically connected between the positive electrode wiring pattern and the negative electrode wiring pattern of the circuit module 120 to perform charging/discharging operations of the bare cell 110 and over-charge/over-discharge preventing operations.

The upper cover 130 is coupled to an upper portion of the bare cell 110 and accommodates the circuit module 120 in its internal space. The upper cover 130 may include a cover plate 131 and a sidewall 134 extending from the cover plate 131 to the circuit module 120.

The cover plate 131 may be formed in a shape substantially similar to that of the top surface 110a of the bare cell 110. The inner surface of the cover plate 131 faces and adjoins the top surface 121a of the circuit board 121. The cover plate 131 includes a throughhole 135 formed at a region corresponding to the external terminal 122 of the circuit module 120. The throughhole 135 exposes the external terminal 122 to the outside to electrically connect the battery pack 100 to a set or a charge/discharge device.

The sidewall 134 includes opposite-end parts 132 positioned at ends in a lengthwise direction of the upper cover 130, and a connection part 133 connecting the opposite-end parts 132. The opposite-end parts 132 make contact with regions of the top surface 110a of the bare cell 110, in proximity to the short-side surfaces 110b and 110c and support the upper cover 130. The connection part 133 extends further toward the circuit module 120 than the opposite-end parts 132. Portions of the connection part 133, covering top portions of the pair of long-side surfaces 110d and 110e of the bare cell 110, are surrounded by a label 160 to later be described.

The adhesion member 140 may be interposed between the bottom surface 110f of the bare cell 110 and the lower cover 150. The adhesion member 140 may adhere the bare cell 110 to the lower cover 150, thereby stably maintaining a state in which the bare cell 110 is adhered to the lower cover 150. The adhesion member 140 may be provided in the form of adhesive paste or a tape. However, the lower cover 150 is configured to surround at least portions of the side surfaces 110b, 110c, 110d and 110e of the bare cell 110. Here, the adhesion member 140 may not be provided as long as the lower cover 150 can be physically connected to the bare cell 110.

The lower cover 150 is coupled to the bottom surface 110f of the bare cell 110 below the bare cell 110. The lower cover 150 includes a plate 151 making contact with the bottom surface 110f of the bare cell 110, a cell support part 152 upwardly protruding from the plate 151 to the bare cell 110, a reinforcement part 153 formed at opposite ends of the plate 151 to protrude downwardly, and a flange fastening part 154 further extending to a lower side of the reinforcement part 153.

The plate 151 may have substantially the same shape as the bottom surface 110f of the bare cell 110 and may be coupled to the bottom surface 110f of the bare cell 110 to make contact with the bottom surface 110f of the bare cell 110. If the adhesion member 150 is provided, it may be adhered to the bottom surface 110f of the bare cell 110.

A pair of cell support parts 152 are formed at edges of the plate 151 along long sides of the plate 151. The cell support parts 152 are coupled to the bare cell 110 while covering lower portions of the long-side surfaces 110d and 110e of the bare cell 110. The cell support parts 152 may be surrounded by the label 160, which will later be described, and maintained at a state in which they are coupled to the bare cell 110. However, in a case where the adhesion member 150 is provided to adhere the bottom surface 110f of the bare cell 110 and the plate 151 to each other, the cell support parts 152 may not be optionally provided by one skilled in the art.

A pair of reinforcement parts 153 are provided at opposite edges of the plate 151. In order to couple the battery pack 110 to a set (not shown), the reinforcement part 153 may be configured to provide strength required for the lower cover 150 when a separate fastening member 10 configured by a screw, such as a bolt, passes through the flange fastening part 154. According, the reinforcement part 153 may prevent the lower cover 150 from being damaged or separated from the bare cell 110 during a fastening process. In addition, in order to allow a rotating tool to be easily rotated to fastening the fastening member 10, the reinforcement part 153 may include a groove 153a in an arc shape, which corresponds to the shape of the fastening hole 154a of the flange fastening part 154.

Here, a thickness t2 of the reinforcement part 153 may be smaller than a thickness t1 of the cell support part 152. In addition, the thickness t2 of the reinforcement part 153 may be greater than or equal to about 0.4 mm. Here, when the thickness t2 of the reinforcement part 153 is greater than or equal to about 0.4 mm, the reinforcement part 153 may provide strength required for fastening the reinforcement part 153 to the set. In addition, an upper limit of the thickness t2 of the reinforcement part 153 is not required because the thickness t2 of the reinforcement part 153 only needs to be greater than or equal to about 0.4 mm. In the battery pack 100 according to the instant embodiment, the reinforcement part 153 can be formed thinly, thereby increasing a height of the bare cell 110 and ultimately increasing the capacity.

A pair of flange fastening parts 154 are provided to downwardly extend from the reinforcement part 153. In addition, the pair of flange fastening parts 154 are positioned between two short-side surfaces 110b and 110c of the bare cell 110 and may not protrude further than the bare cell 110 and the plate 151 in lengthwise directions of the long-side surfaces 110d and 110e. Therefore, a space required for the flange fastening parts 154 may be minimized within the set.

In addition, a rear surface (154b in a (−) direction of the x axis of FIG. 2) of each of the flange fastening parts 154 is flatly formed to make close contact with a portion of a set (not shown) to be combined with the flange fastening part 154.

In addition, a fastening hole 154a parallel with short sides of the plate 110 is formed in the flange fastening part 154. In a state in which the rear surface (154b in a (−) direction of the x axis of FIG. 2) of each of the flange fastening parts 154 makes close contact with the portion of the set to be combined with the flange fastening part 154, an external fastening member 10 passes through the fastening hole 154a from a front surface (in a (+) direction of the x axis of FIG. 2) to allow the flange fastening parts 154 to be easily combined with the set. In addition, the fastening hole 154a includes a screw thread to then be stably combined with the fastening member 10. Therefore, the battery pack 100 according to the embodiment of the present disclosure can be easily fastened in the set by the flange fastening parts 154.

In addition, since the flange fastening parts 154 are provided and a separate fixing member for fixing the battery pack 100 to the set is not required, it is possible to further increase the size of the bare cell 110, thereby ultimately increasing the capacity of the battery pack 100.

The label 160 is attached to surround the side surfaces 110b, 110c, 110d, and 110e of the bare cell 110. The label 160 covers a portion of the connection part 133 of the upper cover 130 and the cell support parts 152 of the lower cover 150. Optionally, the label 160 is configured to first surround the side surfaces 110b, 110c, 110d, and 110e of the bare cell 110, and the cell support part 152 of the lower cover 150 may be coupled to an external surface of the label 160 in contact with the external surface of the label 160.

Hereinafter, a configuration of a battery pack according to another embodiment of the present disclosure will be described.

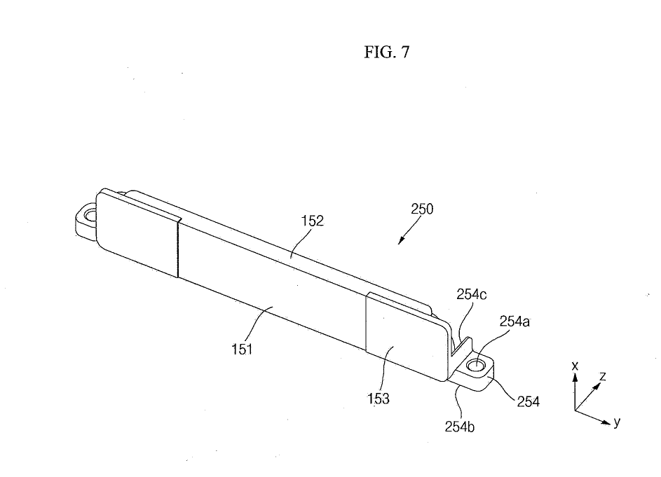

FIG. 6 is a perspective view illustrating a lower cover of a battery pack according to another embodiment of the present disclosure and FIG. 7 is a bottom view of the lower cover of FIG. 6. In FIGS. 6 and 7, the same functional components as those of the previous embodiment are denoted by the same reference numerals, and the following description will focus on differences between the present and previous embodiments. Referring to FIG. 6, the battery pack according to another embodiment of the present disclosure includes a bare cell, a circuit module, an upper cover, and a lower cover 250. The lower cover 250 includes a plate 151, a cell support part 152, a reinforcement part 153, and a flange fastening part 254 upwardly further extending from the reinforcement part 153. A pair of flange fastening parts 254 are provided to upwardly extend from the reinforcement part 153 to the bare cell. In addition, the pair of flange fastening parts 254 are formed to extend in the lengthwise direction of the bare cell.

More specifically, the flange fastening parts 254 are positioned outside the bare cell 110 to surround two short-side surfaces 110b and 110c of the bare cell 110 and protrude from the bare cell 110 in a lengthwise direction of long-side surfaces 110d and 110e (that is, in the y-axis direction of FIG. 6). Here, the flange fastening parts 254 are shaped corresponding to the short-side surfaces 110b and 110c of the bare cell 110 and include a cell fastening surface 254c surrounding the short-side surfaces 110b and 110c. Therefore, the flange fastening parts 254 may be coupled to the bare cell 110 in close contact with the bare cell 110 along the short-side surfaces 110b and 110c of the bare cell 110 through the cell fastening surface 254c.

In addition, a fastening hole 254a parallel with short sides of the plate 110 is formed in the flange fastening part 254. In a state in which a rear surface (254b in a (−) direction of the x axis of FIG. 6) of each of the flange fastening parts 254 makes close contact with a portion of the set to be combined with the flange fastening part 254, an external fastening member 10 passes through the fastening hole 254a from a front surface (in a (+) direction of the x axis of FIG. 6) to allow the flange fastening parts 254 to be easily combined with a set.

Although the present invention has been described with reference to certain exemplary embodiments thereof, it will be understood by those skilled in the art that a variety of modifications and variations may be made to the present invention without departing from the spirit or scope of the present disclosure. The drawings and the detailed description of certain inventive embodiments given so far are only illustrative, and they are only used to describe certain inventive embodiments, but are should not be considered to limit the meaning or restrict the range of the present invention described in the claims. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Therefore, it will be appreciated to those skilled in the art that various modifications may be made and other equivalent embodiments are available. Accordingly, the actual scope of the present invention must be determined by the spirit of the appended claims, and equivalents thereof.

What is claimed is:

1. A battery pack, comprising:
a bare cell having electrode terminals protruding from a first surface; and
a lower cover coupled to a second surface of the bare cell positioned opposite the first surface,
wherein the lower cover includes a flange fastening part protruding away from the second surface of the bare cell, and
wherein the flange fastening part has a fastening hole formed therein.

2. The battery pack of claim 1, wherein the lower cover is coupled to the second surface of the bare cell by an adhesion member.

3. The battery pack of claim 1, wherein the lower cover includes a cell support part protruding on two sides of a plate and contacting both the second surface of the bare cell and a lower side portion of the bare cell.

4. The battery pack of claim 3, further comprising an adhesion member formed between the plate of the lower cover and the second surface of the bare cell.

5. The battery pack of claim 1, wherein the flange fastening part of the lower cover is formed at two opposite edges of the lower cover.

6. The battery pack of claim 1, wherein a portion of the flange fastening part protrudes toward a lower portion of the bare cell.

7. The battery pack of claim 1, wherein a portion of the flange fastening part protrudes from the cover towards a lower side portion of the bare cell and extends in a lengthwise direction of the bare cell.

8. The battery pack of claim 7, wherein the flange fastening part a cell fastening surface shaped corresponding to the bare cell in two regions contacting opposite ends of the lower portion of the bare cell.

9. The battery pack of claim 1, wherein the flange fastening part is formed with a flat contact surface.

10. The battery pack of claim 1, wherein the fastening hole has a screw thread formed therein.

11. The battery pack of claim 1, wherein the lower cover further includes a reinforcement part formed between a plate contacting the second surface of the bare cell and the flange fastening part.

12. The battery pack of claim 11, wherein the reinforcement part has a thickness of about 0.4 mm or greater.

13. The battery pack of claim 11, wherein the reinforcement part includes an arc-shaped groove corresponding to the shape of the fastening hole.

14. The battery pack of claim 11, wherein the lower cover includes a plate contacting the second surface of the bare cell and a cell support part protruding from the plate and surrounding two opposite sides of a lower portion of the bare cell in a lengthwise direction of the bare cell.

15. The battery pack of claim 14, wherein the reinforcement part has a thickness smaller than a thickness of the cell support part.
